(19) United States
(12) Patent Application Publication
(10) Pub. No.: US 2023/0298466 A1
(43) Pub. Date: Sep. 21, 2023

(54) METHOD FOR CHECKING AN EFFECT CHAIN

(71) Applicant: Robert Bosch GmbH, Stuttgart (DE)

(72) Inventor: Stefan Nordbruch, Leonberg (DE)

(21) Appl. No.: 18/173,508

(22) Filed: Feb. 23, 2023

(30) Foreign Application Priority Data
Mar. 21, 2022 (DE) 10 2022 202 717.5

(51) Int. Cl. G08G 1/0967

(52) U.S. Cl. CPC G08G 1/096766; G08G 1/096725

(57) ABSTRACT

A method for checking an effect chain, which includes multiple components, for an infrastructure-based, at least semiautomated control of a motor vehicle within an infrastructure. The method includes: receiving state signals which represent a state of the effect chain, setting up at least one digital twin of the components of the effect chain based on the state signals, checking the effect chain with the aid of the at least one digital twin to determine whether the effect chain is suitable for an infrastructure-based, at least semiautomated control of a motor vehicle, determining whether the effect chain is suitable for an infrastructure-based, at least semiautomated control of a motor vehicle within the infrastructure based on the check.

### CROSS REFERENCE

The present application claims the benefit under 35 U.S.C. § 119 of German Patent Application No. DE 10 2022 202 717.5 filed on Mar. 21, 2022, which is expressly incorporated herein by reference in its entirety.

### FIELD

The present invention relates to a method for checking an effect chain, which includes multiple components, for an infrastructure-supported, at least semiautomated control of a motor vehicle within an infrastructure, and it relates to a device, a computer program, and a machine-readable memory medium.

### BACKGROUND INFORMATION

German Patent Application No. DE 10 2018 205 872 A1 describes a method for generating a digital twin of a physical object.

German Patent Application No. DE 10 2012 222 562 A1 describes a system for managed parking areas for transferring a vehicle from a starting position to a destination position.

### SUMMARY

An object of the present invention includes efficiently checking an effect chain which includes multiple components, for an infrastructure-supported, at least semiautomated control of a motor vehicle within an infrastructure.

This object may be achieved by the present invention.

Advantageous refinements and example embodiments of the present invention are disclosed herein.

According to a first aspect of the present invention, a method is provided for checking an effect chain, which includes multiple components, for an infrastructure-based, at least semiautomated control of a motor vehicle within an infrastructure. According to an example embodiment of the present invention, the method includes the following steps:
receiving state signals which represent a state of the effect chain,
setting up at least one digital twin of the components of the effect chain based on the state signals,
checking the effect chain with the aid of the at least one digital twin to determine whether the effect chain is suitable for an infrastructure-based, at least semiautomated control of a motor vehicle,
determining whether the effect chain is suitable for an infrastructure-base, at least semiautomated control of a motor vehicle based on the check.

According to a second aspect of the present invention, a device is provided which is designed to execute all steps of the method according to the first aspect.

According to a third aspect of the present invention, a computer program is provided, which includes instructions that when a computer, e.g., the device according to the second aspect, executes the computer program, the computer is induced to execute a method according to the first aspect.

According to a fourth aspect of the present invention, a machine-readable memory medium is provided on which the computer program according to the third aspect is stored.

The present invention is based on the understanding, and encompasses this understanding, that the above object is achieved by not checking the effect chain directly but checking a digital image of the at least one digital twin of the components of the effect chain. Thus, no check of the real effect chain takes place, but a check of the virtual effect chain is carried out. As a result, for example, the effect chain, i.e., especially one or more component(s) of the effect chain, can be checked also if, for instance, no communication link exists between the checking instance and the effect chain or the components of the effect chain. The checking of the virtual effect chain also provides the technical advantage that even if a communication link between the checking instance and the effect chain or the component is possible or if such a link exists, such a communication link is not required in the first place. For example, this provides the technical advantage of enabling an efficient check of the effect chain.

The present invention may particularly allow for an efficient check of an effect chain including multiple components for an infrastructure-based, at least semiautomated control of a motor vehicle within an infrastructure.

In English, the wording ‘infrastructure-assisted driving’ is often used for the phrase ‘infrastructure-based, at least semiautomated control of a vehicle’.

In one example embodiment of the present invention, setting up the at least one digital twin includes setting up an individual digital twin for a component and/or setting up a digital twin jointly for multiple components.

For instance, this provides the technical advantage that the at least one digital twin is able to be set up in an efficient manner.

In one example embodiment of the method of the present invention, the check includes checking whether the effect chain as a whole and/or one or more component(s) satisfies or satisfy a predetermined safety integrity level, in particular an ASIL and/or a SIL.

For instance, this provides the technical advantage that the check can be carried out in an efficient manner.

In one embodiment of the method of the present invention, it is provided that weather signals are received which represent a weather of the infrastructure, and the checking of the effect chain is carried out based on the weather signals.

For example, this achieves the technical advantage that an efficient check can be carried out. More specifically, this achieves the technical advantage that the reality is able to be virtually imaged in the truest way possible.

In one embodiment of the method of the present invention, it is provided that a digital weather twin of the weather is set up based on the weather signals, and the checking of the effect chain is carried out based on the digital weather twin.

For instance, this provides the technical advantage that an efficient check is able to be carried out.

In one embodiment of the method of the present invention, it is provided that the weather is integrated into an already prepared digital twin of the components of the effect chain.

For example, this provides the technical advantage that the check is able to be carried out in an efficient manner.

In one embodiment of the method of the present invention, it is provided that map signals are received which represent a digital map of the infrastructure, and the check of the effect chain is able to be carried out based on the digital map.

For instance, this provides the technical advantage that the reality in which the motor vehicle is situated can be virtually imaged in the truest manner possible.

In one embodiment of the method of the present invention, it is provided that a digital map twin is set up based on the map signals, and the check of the effect chain is carried out based on the digital map twin.

For instance, this provides the technical advantage that the check is able to be carried out in an efficient manner.

In one embodiment of the method of the present invention, it is provided that the digital map is integrated into an already prepared digital twin of the components of the effect chain.

For example, this provides the technical advantage that the check can be carried out in an efficient manner.

According to one embodiment of the present invention, it is provided that the multiple components in each case are an element selected from the following group of components: an environment sensor, a communication device, a motor vehicle, a control device of the motor vehicle, an actuator of the motor vehicle, a traffic light system of the infrastructure, an electronic traffic sign of the infrastructure, an infrastructure-side computer for calculating infrastructure assistance data on the basis of which the motor vehicle is able to be controlled in an at least semiautomated manner, a traffic light system of the infrastructure, and a barrier of the infrastructure.

For instance, this provides the technical advantage that especially suitable components are able to be checked.

In one embodiment of the method of the present invention, it is provided that the state includes one or more of the following state parameter(s): a type of component, a characteristic of a component, especially the specific safety integrity level it satisfies, especially ASIL and/or SIL, a capacity utilization of a component, in particular a memory, computing time, maintenance data of a component which especially indicate a date of the most recent maintenance, operating data of the component which in particular indicate whether or not the component is in operation, history data of the component, which describe a history of the component, prediction data of a component, which describe a predicted state of the component.

For example, this provides the technical advantage that the state can be described in an efficient manner.

A history of the components, for example, includes the following: information about one or more failure(s) of the component and/or an indication of one or more performed maintenance operation(s) of the component and/or about one or more scheduled maintenance operation(s) of the component, and/or the age of the component and/or error data of the component.

According to an example embodiment of the present invention, a component of the effect chain, for instance, is one of the following components: an environment sensor, a control device of the motor vehicle, a main control device of the motor vehicle, a communication interface of the motor vehicle, a communication interface of the infrastructure, a computer designed to ascertain infrastructure assistance data for the infrastructure-based, at least semiautomated control of a motor vehicle within an infrastructure, a cloud infrastructure in which one or more component(s) of the infrastructure is/are implemented.

Unless specified otherwise, a component in the sense of the description, for example, is an infrastructure-side component or a motor vehicle-side component.

A component of the effect chain is the motor vehicle, for instance.

In one embodiment of the method of the present invention, it is provided that the infrastructure has one or more of the following infrastructure element(s): a parking lot, a tunnel, an expressway on-ramp, an expressway off-ramp, a hub, in particular a traffic circle, an intersection, a junction, a T-intersection, a zebra crossing, a construction site, a bridge, underpass, toll station, parking garage.

For example, this provides the technical advantage that especially important effect chains are checked with regard to an at least semiautomated control of a motor vehicle within a specific infrastructure.

For instance, an infrastructure-based, at least semiautomated control of the vehicle includes an infrastructure-based assistance for the motor vehicle during an at least semiautomatically controlled travel within the infrastructure, for instance within a parking lot.

In one embodiment of the method of the present invention according to the first aspect, it is provided, for example, that the motor vehicle executes an AVP operation within the parking lot.

The abbreviation ‘AVP’ stands for automated valet parking, and it can be translated as ‘automatic parking service’ in German. An AVP operation, for instance, includes an at least highly automated control of the motor vehicle from a drop-off position to a parking position and, for instance, an at least highly automated control of the motor vehicle from a parking position to a pickup position. At the drop-off position, a driver of the motor vehicle hands over the motor vehicle for an AVP operation. At a pickup position, the motor vehicle is picked up at the conclusion of the AVP operation.

A motor vehicle in the sense of the description may thus also be referred to as an AVP motor vehicle, provided it is designed to carry out an AVP procedure, for instance.

For example, it is provided that the AVP procedure includes an AVP procedure according to the AVP types 1, 2 and/or 3, an AVP type 1 being a motor-vehicle-centric AVP operation, an AVP type 2 being an infrastructure-centric AVP operation, and an AVP type 3 being a motor vehicle-infrastructure-divided AVP operation.

For instance, this provides the technical advantage that the AVP operation is able to be carried out in an efficient manner.

The AVP type 1 characterizes a motor-vehicle-centric AVP operation. The main responsibility for the AVP procedure lies with the motor vehicle.

The AVP type 2 characterizes an infrastructure-centric AVP operation. The main responsibility for the AVP procedure lies with the infrastructure, that is, with the AVP system.

The AVP type 3 characterizes an AVP operation shared between a motor vehicle and an infrastructure. In this case, the main responsibility for the AVP procedure is shared between the motor vehicle and the AVP system.

An AVP operation includes the following actions or functions:

1. Determining a target position for the motor vehicle that lies within the parking lot.

2. Planning a route from a starting position encompassed by the parking lot to the destination position.

3. Detecting an object and/or an event as well as a corresponding reaction to a detected object and/or a detected event.

4. Locating the motor vehicle within the parking lot.

5. Calculating a setpoint trajectory for the motor vehicle based on the planned route.

6. Controlling a lateral and longitudinal guidance of the motor vehicle based on the calculated setpoint trajectory.

An assignment as to which of these procedures or functions is carried out depending on the AVP type of the motor vehicle or of an infrastructure-side AVP system which, for instance, may include the system according to the second aspect, is indicated in the following table; here ‘I’ stands for ‘infrastructure’, i.e., for the AVP system, and ‘MV’ stands for ‘motor vehicle’, so that ‘I’ indicates that the operation is carried out by the AVP system, and ‘MV’ indicates that the operation is carried out by the motor vehicle:

| Functions | AVP Type 1 | AVP Type 2 | AVP Type 3 |
|---|---|---|---|
| Determining a target | I & K | I | I |
| position for the motor | | | |
| vehicle that lies | | | |
| within the parking | | | |
| space. | | | |
| Planning a route from | MV | I | H |
| a starting position | | | |
| encompassed by the | | | |
| parking lot to the | | | |
| target position. | | | |
| Detecting an object | MV (& | I | I & MV |
| and/or an event as | optionally | | |
| well as a | I) | | |
| corresponding reaction | | | |
| to a detected object | | | |
| and/or a detected | | | |
| event. | | | |
| Locating the motor | MV | I | MV |
| vehicle within the | | | |
| parking lot. | | | |
| Calculating a setpoint | MV | I | MV |
| trajectory for the | | | |
| motor vehicle based on | | | |
| the planned route. | | | |
| Controlling a lateral | MV | MV | MV |
| and longitudinal | | | |
| guidance of the motor | | | |
| vehicle based on the | | | |
| calculated setpoint | | | |
| trajectory. | | | |

The above table therefore indicates for each function, specifically for each AVP type, whether the function is carried out by the infrastructure, that is, by an infrastructure-side AVP system, or by the motor vehicle, that is, by a motor-vehicle-side AVP system, for instance. In some cases, it may be provided that the function is carried out by both the infrastructure-side AVP system and the motor vehicle, i.e., by the motor-vehicle-side AVP system.

With regard to the object and event detection for the AVP type 1, it may optionally be provided that in addition to the motor vehicle, the AVP system of the infrastructure also executes this function.

The described AVP types 1, 2 and 3 are described in greater detail in ISO 23374.

The wording ‘at least semiautomated control’ includes one or more of the following cases: an assisted control, a semiautomated control, a highly automated control, a fully automated control. The wording ‘at least semiautomated’ thus includes one or more of the following terms: assisted, semiautomated, highly automated, and fully automated.

An assisted control means that a driver of the motor vehicle permanently carries out either the lateral or the longitudinal guidance of the motor vehicle. The respective other driving task (that is, a control or the longitudinal or the lateral guidance of the motor vehicle) is carried out automatically. In other words, either the lateral or the longitudinal control is automatically carried out in an assisted control of the motor vehicle.

A semiautomated control means that, in a specific situation (e.g., travel on an expressway, travel within a parking lot, overtaking an object, travel within a traffic lane specified by lane markings) and/or for a specific period of time, a longitudinal and lateral guidance of the motor vehicle is controlled automatically. There is no need for a driver of the motor vehicle to manually perform the longitudinal and lateral guidance of the motor vehicle by himself. However, the driver must monitor the automatic control of the longitudinal and lateral guidance on a permanent basis in order to be able to manually intervene if the need arises. The driver must be prepared to assume the full control of the motor vehicle guidance at all times.

A highly automated control means that for a specific period of time in a specific situation (e.g., travel on an expressway, travel within a parking lot, overtaking an object, travel within a traffic lane specified by lane markings), a longitudinal and lateral guidance of the motor vehicle are controlled automatically. A driver of the motor vehicle is not required to manually control the longitudinal and lateral guidance of the motor vehicle by himself. There is no need for the driver to permanently monitor the automatic control of the longitudinal and lateral guidance in order to be able to manually intervene in case that becomes necessary. If required, a takeover prompt will automatically be output to the driver to assume the control of the longitudinal and lateral guidance, in particular with a sufficient time reserve. In other words, the driver must potentially be able to assume control of the longitudinal and lateral guidance. Limits of the automatic control of the lateral and longitudinal guidance are automatically detected. In a highly automated guidance, however, it is not possible to automatically induce a minimum-risk state in every starting situation.

A fully automated control means that in a specific situation (e.g., travel on an expressway, travel within a parking lot, overtaking an object, travel within a traffic lane specified by lane markings), a longitudinal and lateral guidance of the motor vehicle is automatically controlled. A driver of the motor vehicle does not have to manually control the longitudinal and lateral guidance of the motor vehicle on his own. There is no need for the driver to monitor the automatic control of the longitudinal and lateral guidance in order to manually intervene, if necessary. Prior to the conclusion of the automatic control of the lateral and longitudinal guidance, a prompt will automatically be output to the driver to assume the driving task (control of the lateral and longitudinal guidance of the motor vehicle), in particular with a sufficient time reserve. If the driver does not assume the driving task, an automatic return to a minimum-risk state will be implemented. Limits of the automatic control of the lateral and longitudinal guidance are automatically detected. In all situations, it is possible to automatically return to a minimum-risk state.

An environment sensor in the sense of the specification, for example, is one of the following environment sensors: a radar sensor, an image sensor, in particular an image sensor of a video camera, an ultrasonic sensor, a LiDAR sensor, a magnetic field sensor, and an infrared sensor.

The embodiments and exemplary embodiments of the present invention described in the specification can be combined with one another in various forms, even if this is not explicitly described.

A digital twin, for example, is a virtual image of the component and/or of multiple components and/or of the weather and/or of the digital map of the environment of the motor vehicle, and of the motor vehicle itself.

For instance, the weather has an effect on the condition of a road of the infrastructure. It is provided, for example, that a road of the infrastructure, especially a part of the road, and/or a road condition of the road, in particular of a part of the road, is represented by an individual digital twin, especially represented by its own digital twin in each case, and/or is integrated into a digital twin already set up, in particular into the digital twin of the infrastructure.

In general, it especially applies that a digital twin is a digital representation of a material and/or immaterial object (or objects such as the components, the weather and the digital map) and/or of a process (or processes) from the real world in the digital world.

The German word ‘sicker’ in the sense of the specification particularly means safe and secure. These two English terms are normally translated as ‘safe’ but sometimes still have a different meaning in the English language.

More specifically, the word ‘safe’ focuses especially on the topic of accident and accident avoidance. In particular, ‘safe’ thus means that measures ensure the correct function of the effect chain, and that a correct sequence of an infrastructure-based, at least semiautomated control of a motor vehicle within an infrastructure is ensured.

The word ‘secure’ particularly focuses on the topic of computer protection and hacker protection, such as especially on the extent to which the effect chain and its components are protected from unauthorized accesses and data manipulations by third parties, also known as hackers. An effect chain that is secure thus especially has appropriate and adequate computer protection and hacker protection.

Checking whether the infrastructure-side effect chain is suitable for infrastructure-supported, at least semiautomated driving may thus provide the special technical advantage that it can be efficiently ensured that the effect chain is safe in the sense of the specification, i.e., safe especially in the sense of the English terms ‘safe’ and ‘secure’.

The check, for instance, includes checking whether one or more safety condition(s) is/are satisfied.

For example, it is provided that the one or more safety condition(s) is/are an element selected from the following group of safety condition(s): the existence of a predetermined minimum ASIL and/or minimum SIL in at least one of the components of the effect chain, the existence of a redundancy in at least one of the components, the existence of a diversity in at least one of the components, the existence of at least one plan which includes measures for reducing errors and/or measures in failures of at least one of the components of the effect chain, and/or which includes measures for an error analysis and/or which includes measures in error interpretations, the existence of one or more fallback scenarios.

For instance, this provides the technical advantage that particularly suitable safety conditions are provided.

The abbreviation “ASIL” stands for the English terms ‘Automotive Safety Integrity Level’. An automotive safety integrity level is a key component of the ISO standard 26262. ASIL differentiates between four different ASIL risk stages, which are denoted by ASIL-A, ASIL-B, ASIL-C and ASIL-D.

As also in German, the abbreviation ‘SIL’ stands for the English terms ‘Safety Integrity Level’. A safety integrity level is a key component of the IEC EN standard 61508. SIL differentiates between four different SIL risk levels, which are denoted by SIL-1, SIL-2, SIL-3 and SIL-4.

An infrastructure-based assistance of the motor vehicle in particular means that infrastructure assistance data are made available to the motor vehicle. Based on the infrastructure assistance data, the motor vehicle, for instance, is able to derive action instructions. For example, based on the infrastructure assistance data, the motor vehicle can decide by itself how to proceed.

Infrastructure assistance data, for instance, include one or more of the following element(s) of data: a control instruction for the at least semiautomated control of a lateral and/or longitudinal guidance of the vehicle; a remote control instruction for the at least semiautomated remote control of a lateral and/or longitudinal guidance of the motor vehicle; a release instruction to enable an at least semiautomated, in particular fully automated, travel of the motor vehicle for a specific time in a specific region of the infrastructure; a setpoint trajectory for the motor vehicle; a target position within the infrastructure; environment data, which represent an environment of the motor vehicle; a specification indicating what the motor vehicle is to do. The specification specifies whether the motor vehicle may drive or must stop, for example.

In one embodiment of the method according to the present invention, it is provided that temporally after the receipt of state signals that represent a state of the effect chain, temporally later state signals, which represent a state of the effect chain at a later point in time, are received at a later time, and the at least one prepared digital twin is updated based on the temporally later state signals, and the effect chain is checked with the aid of the at least one updated digital twin in order to determine whether the effect chain is suitable for an infrastructure-based, at least semiautomated control of a motor vehicle, and based on the renewed check, it is determined anew whether the effect chain is suitable for an infrastructure-based, at least semiautomated control of a motor vehicle (4032) within the infrastructure.

For instance, this provides the technical advantage that the effect chain can be checked based on an updated twin. Thus, for example, the at least one digital twin is regularly updated based on the current state signals, which represent a current state of the effect chain, so that the checking and the determining are able to be appropriately carried out on a regular basis.

For instance, the renewed check includes performing a check to determine whether the effect chain as a whole and/or one or more component(s) satisfies/satisfy a predefined safety integrity level, in particular an ASIL and/or a SIL.

Statements that are made herein in connection with the initial checking and determining similarly apply to one or more later check step(s) and determination step(s), and vice versa.

The words ‘assist” and ‘support’ may be used interchangeably.

The abbreviation ‘at least one’ means ‘one or more’.

The present invention will be described in greater detail in the following text based on preferred exemplary embodiments.

### BRIEF DESCRIPTION OF THE DRAWINGS

FIG. 1 shows a flow diagram of an example method according to the first aspect of the present invention.

FIG. 2 shows an example device according to the second aspect of the present invention.

FIG. 3 shows a machine-readable memory medium according to the fourth aspect of the present invention.

FIGS. 4-8 each shows a digital twin in each case.

In the following text, the same reference numerals may be used for identical features.

### DETAILED DESCRIPTION OF EXAMPLE EMBODIMENTS

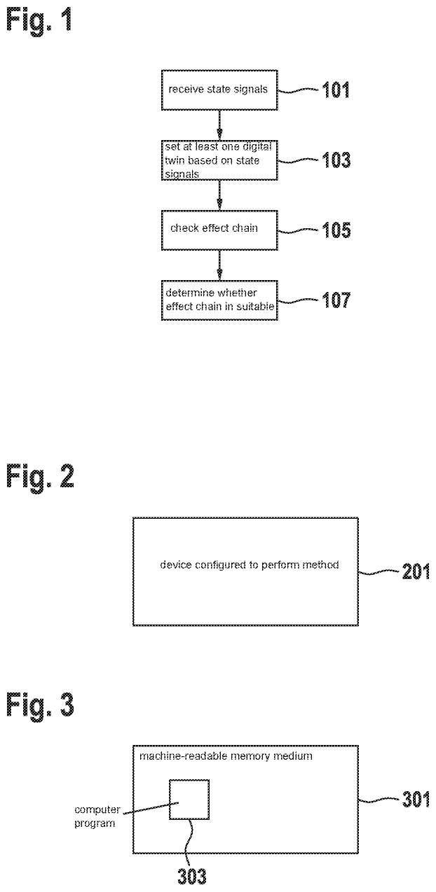

FIG. 1 shows a flow diagram of a method for checking an effect chain, which includes multiple components, for an infrastructure-based, at least semiautomatic control of a motor vehicle within an infrastructure, the method including the following steps:
Receiving 101 state signals, which represent a state of the effect chain,
setting up 103 at least one digital twin of the components of the effect chain based on the state signals,
checking 105 the effect chain with the aid of the at least one digital twin to determine whether the effect chain is suitable for an infrastructure-based, at least semiautomatic control of a motor vehicle,
determining 107 whether the effect chain is suitable for an infrastructure-based, at least semiautomated control of a motor vehicle within the infrastructure based on the check.

For example, it is determined that the effect chain is unsuitable for an infrastructure-based, at least semiautomated control of a motor vehicle if the check has revealed that the effect chain is not suitable. It is determined that the effect chain is suitable, for instance, if the check has revealed that the effect chain is suitable.

FIG. 2 shows a device 201, which is designed to execute all steps of the method according to the first aspect.

FIG. 3 shows a machine-readable memory medium 301 on which a computer program 303 is stored. Computer program 303 includes instructions that when a computer executes computer program 303, the computer is induced to execute a method according to the first aspect.

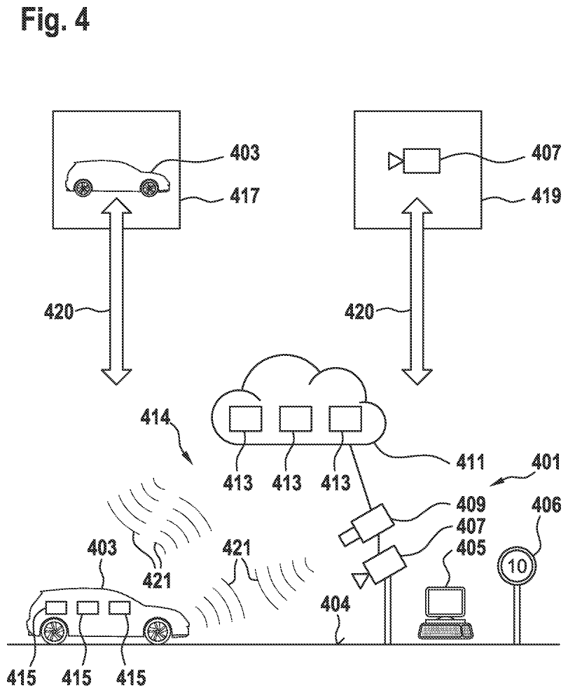

FIG. 4 shows an infrastructure 401 within which a motor vehicle 403 is driving in an at least semiautomated manner. Motor vehicle 403 is driving on a road 404 which is part of infrastructure 401.

Disposed within infrastructure 401 are multiple components 405, 406, 407, 409, 411 and 413 of an effect chain 414 for an infrastructure-based, at least semiautomated control of a motor vehicle.

In detail, component 405 is a computer which is designed to ascertain infrastructure assistance data for an infrastructure-based, at least semiautomated control of a motor vehicle 403 within infrastructure 401, and component 406 is an electronic traffic sign, and component 407 is a video camera which includes an in image sensor (not shown), and component 409 is a further video camera which includes another image sensor (not shown), and component 411 is a cloud infrastructure in which multiple components 413 of effect chain 414 are implemented. These further components 413 may involve a computer, a server, a database, and/or a communication interface, for instance.

Motor vehicle 403 also includes components 415 of effect chain 414. These components 415, for instance, include a control device, a main control device, a communication interface, and/or environment sensors of motor vehicle 403.

This means that effect chain 414 is partially implemented in infrastructure 401 and partially in motor vehicle 403. This applies in general, that is, also unrelated to the exemplary embodiment illustrated in FIG. 4.

A digital twin 417 of motor vehicle 403 is now set up and a digital twin 419 of infrastructure 401, infrastructure 401 being symbolically represented by video camera 407 in the figures.

For instance, it is provided that data from the real world are integrated into the respective digital twin 417, 419, i.e., as input data. And it is provided, for instance, that data from the respective digital twin 417, 419 flow back into the real world. This exchange between the real world and the virtual world is symbolically denoted by a double arrow bearing the reference numeral 420.

In addition, a plurality of wave-shaped and arc-shaped symbols is denoted by reference numeral 421 in FIG. 4, which is meant to symbolically represent a communication between motor vehicle 403 and infrastructure 401. This communication, that is, the communication link, is also part of effect chain 414.

According to FIG. 4, this communication link 421 is also integrated into digital twin 419 of infrastructure 401.

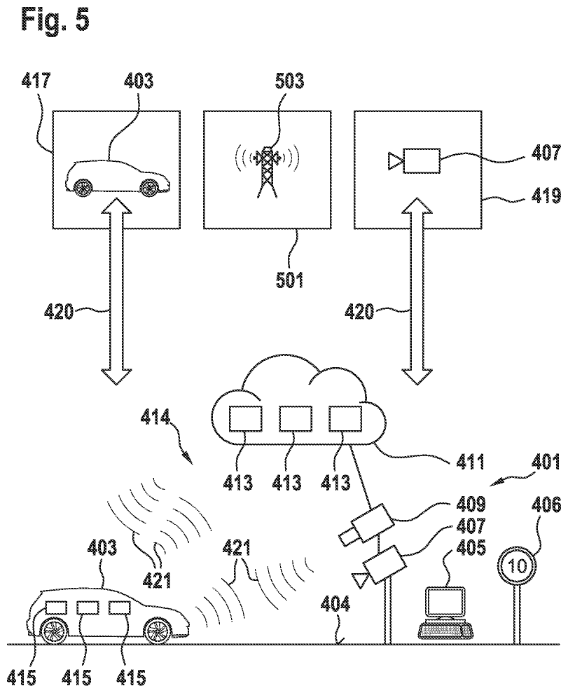

FIG. 5 shows an embodiment according to which this communication link is imaged as its own digital twin 501 in the virtual world. Here, the communication link is denoted by a symbol bearing the reference numeral 503, which is to symbolize an antenna.

Although not illustrated, a data exchange between digital twin 501 and the real world is also able to take place.

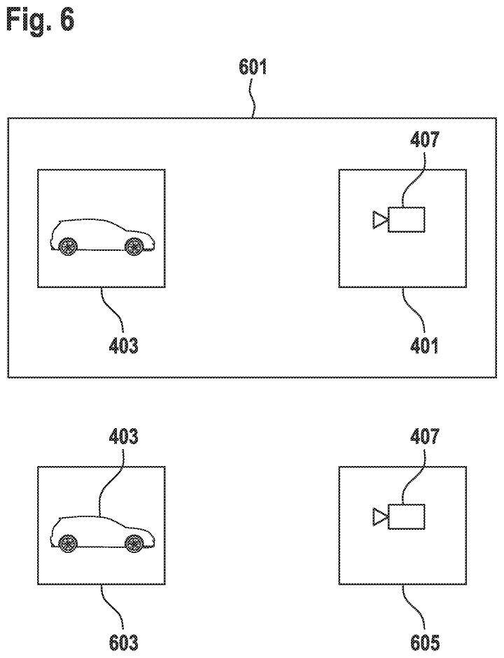

FIG. 6 shows a digital twin 601, which images motor vehicle 403 and infrastructure 401.

In addition, two further digital twins 603 and 605 are illustrated in FIG. 6, digital twin 603 imaging motor vehicle 403 and digital twin 605 imaging infrastructure 401, symbolically represented by video camera 407.

Thus, it may be provided that a separate digital twin is set up for each component of the effect chain, and it may be provided, for instance, that multiple components of the effect chain are jointly combined in a digital twin or are imaged by this digital twin.

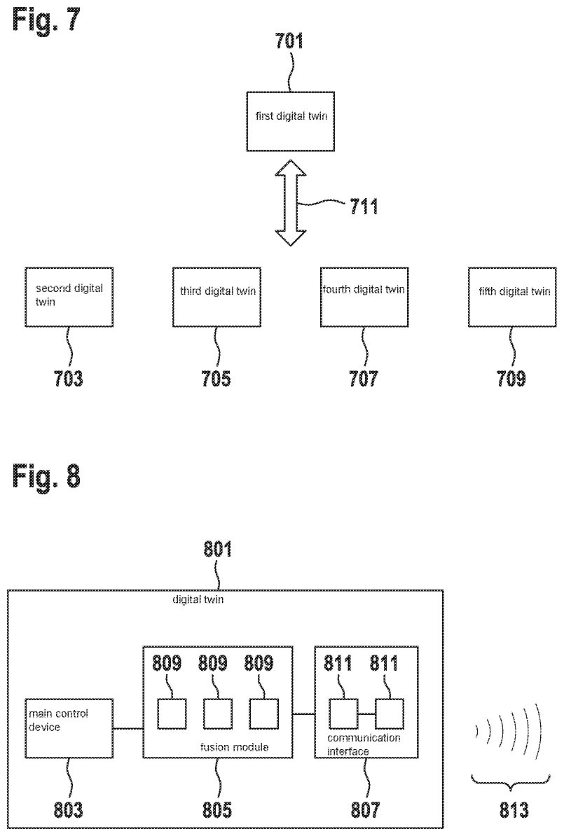

FIG. 7 shows a plurality of digital twins: a first digital twin 701, a second digital twin 703, a third digital twin 705, a fourth digital twin 707, and a fifth digital twin 709. These five digital twins 701, 703, 705, 707, 709 are able to interact with one another, that is, communicate with one another, which is symbolically represented by a double arrow bearing the reference numeral 711.

First digital twin 701 images the infrastructure, second digital twin 703 images the motor vehicle, and third digital twin 705 is a digital map twin. Fourth digital twin 707 is a digital weather twin. Fifth digital twin 709 is a further digital twin, for instance a digital twin of a road of the infrastructure together with a condition of the road.

FIG. 8 show a digital twin 801, which images the motor vehicle. Digital twin 801, for example, images components of the motor vehicle. These components have the following reference numerals: 803, 805, 807, 809, 811.

For instance, component 803 is a main control device of the motor vehicle. Component 805, for example, is a fusion module of the motor vehicle in which a data fusion of environment sensor data from environment sensors of the motor vehicle is performed. Components 80 which are encompassed by fusion module 805, for example, are a processor, a memory, an interface with further components of the motor vehicle.

Component 807, for instance, is a communication interface of the motor vehicle. Components 811 of the communication interface, for example, include an antenna and/or a software model based on which a communication is able to be carried out.

The motor vehicle communicates with an infrastructure (not shown) by way of a communication link 813. This communication link 813 may be part of an effect chain for an infrastructure-based, at least semiautomated control, for example.

It is provided that the state signals, which represent the state of the effect chain, include information about the fusion module, for instance. Such information, for example, includes a capacity utilization of the memory, a processing time, a safety integrity level of the fusion module, and information indicating since when the fusion module has been in operation.

This advantageously makes it possible for fusion module 805 to be virtually imaged or represented by a digital twin in an efficient manner.

In summary, instead of checking the effect chain for an infrastructure-based, at least semiautomated control of a motor vehicle within an infrastructure in reality, the described concept is particularly based on checking it in the virtual world. The check can ensure that the conditions that must exist for an infrastructure-based, at least semiautomated control of a motor vehicle within an infrastructure are satisfied.

It is provided that the components of the effect chain with their current characteristics are imaged or stored as a digital twin or as a plurality of digital twins, e.g., stored in one or in multiple database(s).

This means that one or more digital twin(s) exit(s), which is/are a virtual image of the effect chain.

For instance, it is provided that the digital twins are updated on a continuous basis.

It is ensured, for example, that for the current instant, i.e., for the current planning of an infrastructure-based, at least semiautomated control of a motor vehicle within the infrastructure, and/or for a planning in the future, this control is able to be executed or carried out in a safe manner in the sense of the specification.

The digital twin or the digital twins image(s) a system state, in particular a current state, which, for instance, is defined and current for the effect chain, in particular for the entire effect chain including all associated components and their characteristics and states.

What is claimed is:

1. A method for checking an effect chain, which includes multiple components, for an infrastructure-based, at least semiautomatic control of a motor vehicle within an infrastructure, the method comprising the following steps:
receiving state signals which represent a state of the effect chain;
setting up at least one digital twin of the components of the effect chain based on the state signals;
checking the effect chain using the at least one digital twin to determine whether the effect chain is suitable for the infrastructure-based, at least semiautomated control of the motor vehicle; and
determining whether the effect chain is suitable for the infrastructure-based, at least semiautomated control of the motor vehicle within the infrastructure, based on the check.

2. The method as recited in claim 1, wherein setting up the at least one digital twin includes setting up an individual digital twin for a component of the effect chain and/or setting up a digital twin jointly for multiple components of the effect chain.

3. The method as recited in claim 1, wherein the check includes checking whether the effect chain as a whole and/or one or more components of the effect chain satisfies a predetermined safety integrity level.

4. The method as recited in claim 3, wherein the predetermined safety level is an ASIL and/or a SIL.

5. The method as recited in claim 1, wherein weather signals are received which represent a weather of the infrastructure, and the checking of the effect chain is carried out based on the weather signals.

6. The method as recited in claim 5, wherein a digital weather twin of the weather is set up based on the weather signals, and the check of the effect chain is carried out based on the digital weather twin.

7. The method as recited in claim 5, wherein the weather is integrated into an already prepared digital twin of the components of the effect chain.

8. The method as recited in claim 1, wherein map signals are received which represent a digital map of the infrastructure, and the check of the effect chain is carried out based on the digital map.

9. The method as recited in claim 8, wherein a digital map twin is set up based on the map signals, and the check of the effect chain is carried out based on the digital map twin.

10. The method as recited in claim 8, wherein the digital map is integrated into an already prepared digital twin of the components of the effect chain.

11. The method as recited in claim 1, wherein the multiple components each include an element selected from the following group of components: an environment sensor, a communication device, a motor vehicle, a control device of the motor vehicle, an actuator of the motor vehicle, a traffic light system of the infrastructure, an electronic traffic sign of the infrastructure, an infrastructure-side computer configured to calculate infrastructure assistance data based on which the motor vehicle is able to be controlled in an at least semiautomated manner, a traffic light system of the infrastructure, a barrier of the infrastructure.

12. The method as recited in claim 1, wherein the state includes one or more of the following state parameters: a type of component, a characteristic of a component including safety integrity level it satisfies including an ASIL and/or SIL, a capacity utilization of a component including a memory, processing time, maintenance data of a component which indicate a date of the most recent maintenance; operating data of the component which indicate whether or not the component is in operation, history data of the component which describe a history of the component, prediction data of a component which describe a predicted state of the component.

13. The method as recited in claim 1, wherein the infrastructure has one or more of the following infrastructure elements: a parking lot, a tunnel, an expressway on-ramp, an expressway off-ramp, a hub, in particular a traffic circle, an intersection, a junction, a T-intersection, a zebra crossing, a construction site, a bridge, a tunnel, a toll collection site, a parking garage.

14. The method as recited in claim 1, wherein temporally after receipt of state signals which represent a state of the effect chain, temporally later state signals, which represent a state of the effect chain at a later point in time, are received at a later time, and the at least one prepared digital twin is updated based on the temporally later state signals, the effect chain being checked using the at least one updated digital twin to determine whether the effect chain is suitable for an infrastructure-based, at least semiautomated control of a motor vehicle, and based on the check using the at least one updated digital twin, it is determined anew whether the effect chain is suitable for an infrastructure-based, at least semiautomated control of a motor vehicle within the infrastructure.

15. A device configured to check an effect chain, which includes multiple components, for an infrastructure-based, at least semiautomatic control of a motor vehicle within an infrastructure, the device configured to:
receive state signals which represent a state of the effect chain;
set up at least one digital twin of the components of the effect chain based on the state signals;
check the effect chain using the at least one digital twin to determine whether the effect chain is suitable for the infrastructure-based, at least semiautomated control of the motor vehicle; and
determine whether the effect chain is suitable for the infrastructure-based, at least semiautomated control of the motor vehicle within the infrastructure, based on the check.

16. A non-transitory machine-readable memory medium on which is stored a computer program including instructions for checking an effect chain, which includes multiple components, for an infrastructure-based, at least semiautomatic control of a motor vehicle within an infrastructure, the instructions, when executed by a computer, causing the computer to perform the following steps:
receiving state signals which represent a state of the effect chain;
setting up at least one digital twin of the components of the effect chain based on the state signals;
checking the effect chain using the at least one digital twin to determine whether the effect chain is suitable for the infrastructure-based, at least semiautomated control of the motor vehicle; and
determining whether the effect chain is suitable for the infrastructure-based, at least semiautomated control of the motor vehicle within the infrastructure, based on the check.
